(19) United States
(12) Patent Application Publication
(10) Pub. No.: US 2008/0136664 A1
(43) Pub. Date: Jun. 12, 2008

(54) Inclusion of device permissions and access in a remote control

(75) Inventors: Gary Elsasser, Coto De Caza, CA (US); Kenneth Walker, Trabuco Canyon, CA (US)

Correspondence Address: GATEWAY, INC.;ATTN: Patent Attorney, 610 GATEWAY DRIVE, MAIL DROP Y-04, N. SIOUX CITY, SD, 57049, US

(73) Assignee: Gateway Inc.

(21) Appl. No.: 11/635,705

(22) Filed: Dec. 7, 2006

(51) Int. Cl. G05B 19/02

(52) U.S. Cl. 340/825.22

(57) ABSTRACT

Methods and systems are provided for a limited access remote control system. Embodiments of the invention can include a remote device (202) including logic configured to transmit a control signal to a device (200) to be controlled and logic configured to transmit an access signal to the device (200) to determine an access level available to the remote control (202) that transmits the control and access signals. Embodiments can further include logic configured to receive the control signal (204), logic configured to receive the access signal and/or process the access signal (210) and logic configured to limit the operation (208) of the control signal in accordance with the access level indicated by the access signal.

### BACKGROUND

1. Field

The present invention relates to remote controls. More particularly the invention relates to device permission and access in relation to remote controls.

2. Background

Systems that operate under remote control typically use a single remote control (also referred herein as a “remote”) to control all of the functions available on the system device. While at times, manufacturers have offered “simple” remotes to cover function subsets (e.g., power, channel selection and volume), there is no conceptual difference in relation to the user, simply the keys & therefore the functions that are available. This is echoed in multi-function and after-market remotes that can offer limited or customized sets of functions. In all cases the person possessing the remote control is assumed to be the person with the authority to operate all functions and is able to control anything they can access via the remote control.

Additionally, some remotes have multiple personalities so that different users can get differently programmed user interfaces (UIs) that can offer a reduced set of functions to the user. Moving from user to user on the remote may require the entry of a password or key, but once in a different mode/user ID, all functions are available. Further, there have been tablet PC like devices for the home (e.g., Audrey) that had the notion of fast user switching within the device. When in a different user mode, available functions within the device could be limited based upon user permission. However, these are not system wide function limitations.

Referring to FIG. 1, in conventional systems, access permissions tend to exist within the device itself 100 (e.g., TV, satellite receiver) and are either fully available or controllable via an access control unit 108 (e.g., V-Chip functions or pay-per-view purchase authorization) that can require a user password or key being entered via the remote 102 or other system. The access control unit 108 can serve to override the commands received at the tuner 106 from the remote control 102 via remote receiver 104. However, there is no correlation between limited access remote control devices and device access. An addition to the foregoing devices, RFID tags have been proposed to allow identification of an individual for purposed of controlling programming settings for the individual who have the RFID tag. For example, a user's preferred channel list could be programmed into a receiver based on the RFID tag. However, these devices do not control the device or control permissions or access.

### SUMMARY

Embodiments disclosed herein address the above stated needs by providing systems and methods for including device permissions and access within the remote control itself.

Accordingly, an embodiment of the invention can include an apparatus comprising logic configured to transmit a control signal to a device to be controlled; and logic configured to transmit an access signal to the device to determine an access level available to a remote control that transmits the control and access signals.

Another embodiment of the invention can include a method comprising transmitting a control signal to a device to be controlled; and transmitting an access signal to the device to determine an access level available to a remote control that transmits the control and access signals.

### BRIEF DESCRIPTION OF THE DRAWINGS

The accompanying drawings, which are incorporated in and constitute part of the specification, illustrate various embodiments of the invention. Together with the general description, the drawings serve to explain the principles of the invention. In the drawings:

FIG. 1 illustrates a prior art system that can control access of content.

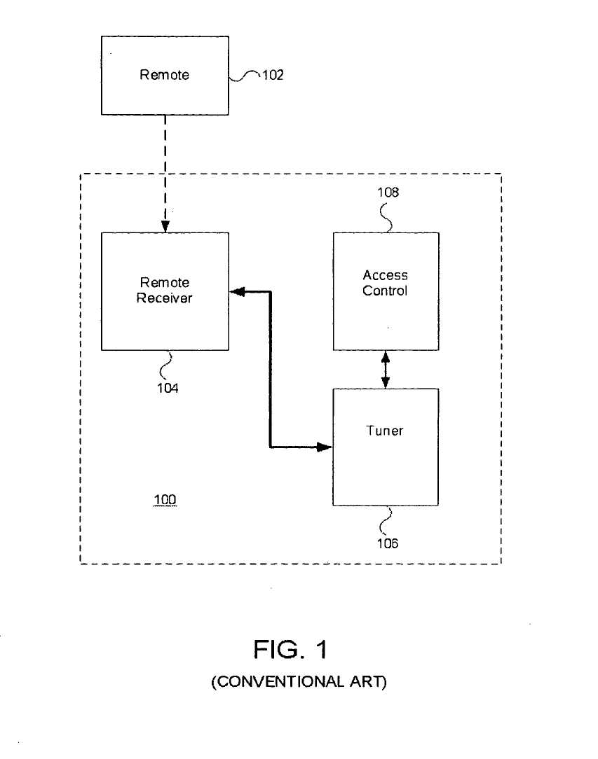

FIG. 2 illustrates a system in accordance with at least one embodiment of the present invention.

FIG. 3 illustrates a method in accordance with at least one embodiment of the present invention.

FIG. 4 illustrates a method in accordance with at least one embodiment of the present invention.

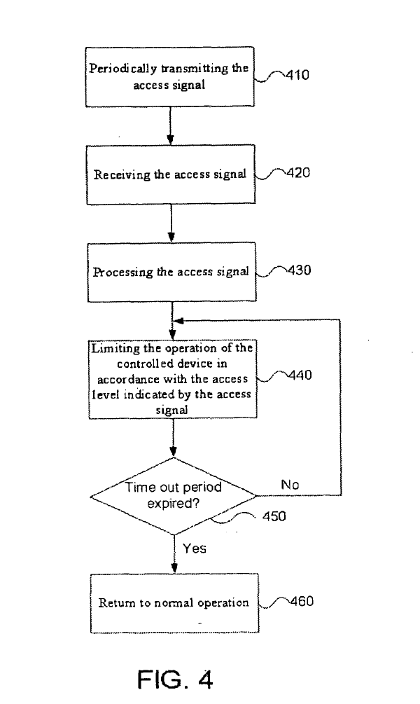

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

Device permission and access limited (DPA) remote control devices according to the present invention embed the user identification and permissions/access-rights in the remote itself. Accordingly, it does not matter if the “administrator” equivalent were to pick up a DPA limited remote, the access rights for the controlled device (e.g., content, programming, web access) would be limited inherently by the DPA remote control. The limitation is inherent in the remote because the DPA remote control device contains the identification and the permission/access level available to that remote.

The DPA remote can have a unique ID tag (e.g., RF and/or IR) that piggybacks along with the remote function command that identifies the command as emanating from a particular DPA remote. For example, the piggyback ID can be a sub carrier that transmits the appropriate command/identification signals. In other embodiments, the piggyback ID can merely be a command prefix or suffix that is transmitted with each command. In yet other embodiments, the piggyback ID can be a specific radio tag ID and may be associated with a separate device (e.g., RFID tag). Using the piggyback ID, any command to turn to a particular channel, launch the programming guide, or access some other function/content can be tagged as being from the DPA remote. Accordingly, systems that are DPA remote aware would then be able to change their behavior based upon the DPA Remotes presence.

In yet another embodiment of the invention, an RF tag or other transmitter that the DPA remote uses to identify itself can establish a general presence with in a room or zone. In this embodiment the identification of the presence of the DPA remote to the room can trigger the limitation of content in accordance with the permissions of the DPA remote. For example, the presence of a DPA remote in a room could shut down the playing of content of a more adult nature even before a responsible person could normally react or even if there is another unlimited remote present or the appropriate codes have been entered to authorize access on the device.

The DPA remote system can alter the behavior of the controlled devices such as limiting the displayed content to that which falls within the ratings range allowed for the DPA remote user (e.g., a child level, teen level, etc.). For example, in the presence of a specific DPA remote closed caption systems could black out words that fall outside the approved range, audio could be blocked that might be objectionable, channels could automatically change to the nearest appropriate channel or the device display could be disabled.

Accordingly, an embodiment of the invention can include an apparatus including logic configured to transmit a control signal to a remote device (e.g., 200) to be controlled and logic configured to transmit an access signal to determine an access level available to a remote control device (e.g., 202) that transmits the control and access signals. As will be appreciated by those skilled in the art, the logic can be any combination of hardware and/or software. For example, if the access signal is transmitted as part of the control signal (e.g., prefix, suffix, or header) the logic configured to transmit the access signal may be additional software code that adds the appropriate codes to the control signal. Further, the access signal may be transmitted as a separate signal from the control signal which could still be software that transmits a separate code via the existing hardware. Alternatively, the access signal can be transmitted in a different mode than the control signal using additional hardware. For example, the access signal can be transmitted as an RF signal (e.g., RFID) and the control signal can be transmitted as an IR signal.

Additional embodiments of the invention can include logic configured to receive the control signal (e.g., 204), logic configured to receive the access signal (e.g., 204/210), and logic configured to process the access signal (e.g., 204/210) and to limit the operation of the control signal in accordance with the access level indicated by the access signal. For example, the remote receiver 204 may receive both the control and the access signals and further may contain the logic to process the access signal to ultimately control tuner 206 directly of via access control logic 208. Alternatively, the receiver and processing unit may be separate devices. For example, the control signal can be IR based and received by remote receiver 204. The access signal can be RF based (e.g., an RFID transmitter) and the DPA decoder/receiver 210 can be RF based (e.g., an RFID receiver) that receives and process the access signal. Further DPA decoder/receiver 210 can control the content access (e.g. tuner 206) either directly or via an existing access control unit 208. Accordingly, those skilled in the art will appreciate that the configurations depicted in the drawings are provided solely for illustration of the invention and the invention is not limited to these configurations.

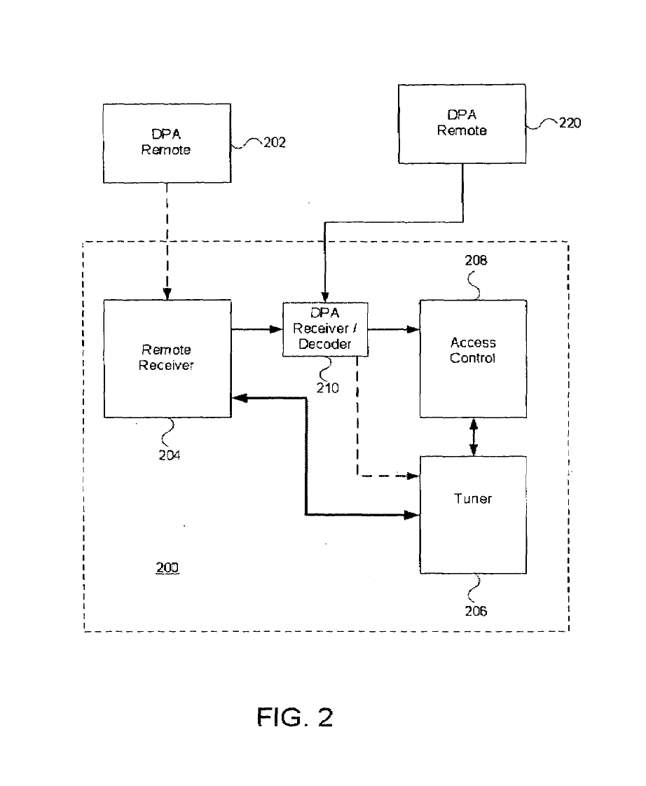

Further, as illustrated in FIG. 2, a permission server 220 may also be operably coupled to the system 200 and other similar systems. For example, the permission server can contain the permission levels for each DPA remote control 202. Accordingly, the permissions would not have to be programmed into each separate system 200. For example, the permission server can be in communication with multiple televisions and the permissions for DPA remote control 202 can be established and communicated to multiple televisions in a home. The permission server 220 may communicate the permission levels based on an individual ID for each DPA remote or the DPA remote may be configured for specific permission levels (e.g., child, teen, etc.) and all remotes set to that level will have access to the defined content. For example, a user can select the programming/content available for a “child” level and these settings can be communicated to multiple devices coupled to the permission server. Alternatively, each DPA remote can have a unique ID and the permission levels can be set for each unique device ID.

The permission server 220 can be implemented on a personal computer or may be a stand alone device. Further, the permission server 220 can be operably coupled to system 200 in any known manner that can communicate data such as, wire or wireless networks, dedicated data connections, and the like. Still further, although the permission server 220 is illustrated as being connected to the DPA receiver/decoder 210, those skilled in the art will appreciate that the functionality described herein can be realized in many alternative configurations and/or may be located in other components of system 200.

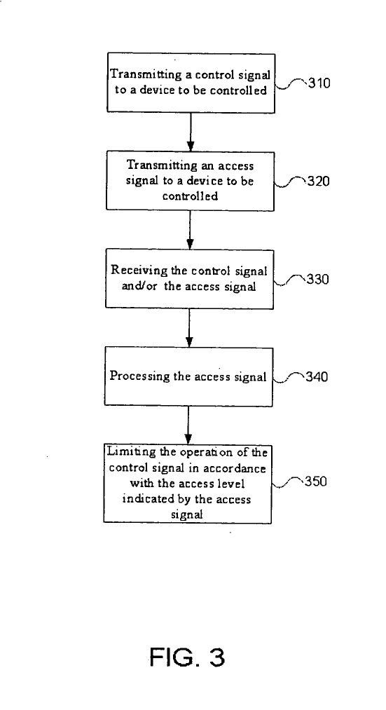

Further, in view of the description provided herein, those skilled in the art will appreciate embodiments of the invention include methods for performing the various steps, functions, or activities described. For example, referring to FIG. 3, embodiments of the invention can include a method including transmitting a control signal to a device to be controlled 310, and transmitting an access signal to the device to determine an access level available to a remote control that transmits the control and access signals, 320. Embodiments of the invention can further include, receiving the control signal and the access signal, 330, processing the access signal, 340, and limiting the operation of the control signal in accordance with the access level indicated by the access signal, 350. Accordingly, a complete system including the remote control and device controlled can be realized.

Further embodiments, can include a method including periodically transmitting the access signal, 410. The DPA remote can periodically transmit its access signal to allow for the device to be controlled to monitor the presence of a restricted DPA remote. Thus, a device (e.g., television, cable receiver, satellite receiver) can be limited to display only appropriate content for the most restricted DPA remote present. For example, if an adult is in a room with an unrestricted remote or even has entered the appropriate codes into a V-Chip or other access device, the adult content would still be restricted if the presence of the limited remote is detected. Accordingly, the method can further include receiving the access signal, 420, processing the access signal, 430, and limiting the device, 440, to be controlled the in accordance with the access level indicated by the access signal. Even if a control signal is not sent from the limited remote, the periodic transmission of the access signal can inform the device that a limited remote is present. The device can continue to limit the device for a predetermined time, 450, after the access signal is no longer received before returning to normal operation, 460. For example, the time out period or continued access limiting period can be coordinated with the period for transmitting the access signal so that the device does not cycle between modes or require continuous transmission of the access signal.

Although the foregoing description was discussed mainly in relation to a video system those skilled in the art will appreciate that embodiments of the invention are not limited to the illustrated and discussed systems. For example, embodiments of the invention can be used for and include entertainment function access, V-Chip control for television, home network function access, Electronic house keys, Remote control systems, PC Access & Password System, and any other system that can have different authorization levels for different users.

The various steps, functions, or activities may be included or excluded as described above, or may be performed in an order different from that depicted in the figures, with the rest of the activities still remaining within the scope of at least one exemplary embodiment. For example, in some embodiments the DPA receiver/decoder 210 may not be present and the functionality can be included in remote receiver 204. Alternatively, DPA receiver/decoder 210 may contain the access control logic and access control unit 208 would not be needed as a separate element. Accordingly, those skilled in the art will appreciate that any combination of integration or separation of the functionalities described herein is within the scope of the present invention whether accomplished by software, hardware or combinations thereof.

Additionally, the invention may be implemented with any sort of processing units, processors and controllers capable of performing the stated functions and activities. For example, the controller may be embodied as a microprocessor, microcontroller, DSP, RISC processor, or any other type of processor or hardwired logic that one of ordinary skill would recognize as being capable of performing the functions described herein. A processing unit in accordance with some embodiments may operate computer software programs stored (embodied) on computer-readable medium such as the memory, flash memory, ram, or other computer readable medium as recognized by one of ordinary skill in the art. The computer software programs can aid or perform the steps and activities described above. For example, computer programs in accordance with at least one exemplary embodiment may include: source code for receiving the control signal and the access signal and processing the access signal and limiting the operation of the control signal in accordance with the access level indicated by the access signal. There are many further source codes that may be written to perform the stated steps and procedures above, and these are intended to lie within the scope of exemplary embodiments.

Accordingly, the description of the various exemplary embodiments provided above is illustrative in nature and is not intended to limit the invention, its application, or uses. Thus, variations that do not depart from the gist of the invention are intended to be within the scope of the embodiments of the present invention. Such variations are not to be regarded as a departure from the spirit and scope of the present invention.

What is claimed is:

1. An apparatus comprising:
logic configured to transmit a control signal to a device to be controlled; and
logic configured to transmit an access signal to the device to determine an access level available to a remote control that transmits the control and access signals.

2. The apparatus of claim 1, wherein the access signal is transmitted as part of the control signal.

3. The apparatus of claim 1, wherein the access signal is transmitted as a separate signal from the control signal.

4. The apparatus of claim 3, wherein the access signal is transmitted in a different mode than the control signal.

5. The apparatus of claim 4, wherein the access signal is transmitted as an RF signal and the control signal is transmitted as an IR signal.

6. The apparatus of claim 1, further comprising:
logic configured to receive the control signal;
logic configured to receive the access signal; and
logic configured to process the access signal and limit the operation of the control signal in accordance with the access level indicated by the access signal.

7. The apparatus of claim 6, wherein the logic configured to receive the control signal and logic configured to receive the access signal are integrated into one device.

8. The apparatus of claim 6, wherein the logic configured to receive the control signal is IR based and the logic configured to receive the access signal is RF based.

9. The apparatus of claim 8, wherein the logic configured to receive the access signal is an RFID receiver.

10. The apparatus of claim 1, further comprising:
a permission server operably coupled to the device to be controlled.

11. A method comprising:
transmitting a control signal to a device to be controlled; and
transmitting an access signal to the device to determine an access level available to a remote control that transmits the control and access signals.

12. The method of claim 11, wherein the access signal is transmitted as part of the control signal.

13. The method of claim 11, wherein the access signal is transmitted as a separate signal from the control signal.

14. The method of claim 13, wherein the access signal is transmitted in a different mode than the control signal.

15. The method of claim 14, wherein the access signal is transmitted as an RF signal and the control signal is transmitted as an IR signal.

16. The method of claim 11, further comprising:
receiving the control signal and the access signal; and
processing the access signal and limiting the operation of the control signal in accordance with the access level indicated by the access signal.

17. The method of claim 16, wherein the access signal is transmitted as an RF signal and the control signal is transmitted as an IR signal.

18. The method of claim 11, further comprising:
periodically transmitting the access signal.

19. The method of claim 18, further comprising:
receiving the access signal; and
processing the access signal and limiting the device to be controlled the in accordance with the access level indicated by the access signal.

20. The method of claim 19, further comprising:
continuing to limit the device for a predetermined time after the access signal is no longer received.
